(19) United States
(12) Patent Application Publication
(10) Pub. No.: US 2026/0168838 A1
(43) Pub. Date: Jun. 18, 2026

(54) MEASUREMENT TRANSDUCER AND FIELD DEVICE

(71) Applicant: Endress+Hauser Flowtec AG, Reinach (CH)

(72) Inventors: Björn Larsson, Birsfelden (CH); Dario Maradan, Münchenstein (CH); Philipp Rimkus, Lörrach (DE)

(21) Appl. No.: 19/129,751

(22) PCT Filed: Oct. 23, 2023
(86) PCT No.: PCT/EP2023/079411

§ 371 Date: May 14, 2025

(30) Foreign Application Priority Data
Nov. 17, 2022 (DE) 10 2022 130 508.2

(51) Int. Cl. G01F 15/14

(52) U.S. Cl. CPC G01F 15/14

(57) ABSTRACT

A measurement transducer for a field device used in metrology and automation for processing a measurement signal from a sensor and for providing measurement values of at least one process variable comprises a housing having a housing body that has in the housing interior thereof at least one housing chamber that is enclosed by a housing wall, an electronics unit having at least one electronics module that has in each case a module holder and at least one electronics component arranged in the module holder, characterized in that the module holder has an electrically conductive module holder body and is designed to shield the at least one electronics component from undesired electrical or electromagnetic effects.

The invention relates to a measurement transducer for a field device for metrology and automation for processing a measurement signal from a sensor and providing measurement values of at least one process variable, and further relates to a field device for metrology and automation for monitoring and/or determining at least one process variable of a medium.

In automation, particularly in process automation, field devices serving to capture and/or modify process variables are frequently used. For detecting process variables, sensors that are integrated, for example, into fill-level measuring devices, flow meters, pressure and temperature measuring devices, pH-redox potential meters, conductivity meters, etc., are used to detect the respective process variables, such as fill-level, flow, pressure, temperature, pH level, or conductivity. Actuators, such as, for example, valves or pumps, are used to influence process variables. The flow rate of a fluid in a pipeline section or a fill-level in a container can thus be altered by means of actuators. In principle, all devices which are process-oriented and which supply or process process-relevant information are referred to as field devices. In connection with the invention, “field devices” therefore also refer to remote I/O's, radio adapters, or, in general, electronic measuring components that are disposed at the field level.

A field device is in particular selected from a group consisting of flow meters, fill-level measuring devices, pressure measuring devices, temperature measuring devices, limit level measuring devices, and/or analytical measuring devices.

Flow meters are, in particular, Coriolis, ultrasound, vortex, thermal, and/or magnetically-inductive flow meters.

Fill-level measuring devices are, in particular, microwave fill-level measuring devices, ultrasonic fill-level measuring devices, time-domain reflectometry measuring devices, radiometric fill-level measuring devices, capacitive fill-level measuring devices, inductive fill-level measuring devices, and/or temperature-sensitive fill-level measuring devices.

Pressure-measuring devices are, in particular, absolute, relative, or differential-pressure devices.

Temperature measuring devices are, in particular, measuring devices with thermocouples and/or temperature-dependent resistors.

Limit-level measuring devices are, in particular, vibronic limit-level measuring devices, ultrasonic limit-level measuring devices and/or capacitive limit-level measuring devices. Analytical measuring devices are, in particular, pH sensors, conductivity sensors, oxygen and active oxygen sensors, (spectro-)photometric sensors, and/or ion-selective electrodes.

The electronics unit with which the measurement signals of the sensor are processed and measurement values of the monitored process variable are provided is usually located in the measurement transducer. For example, DE 20 2014 101 560 U1 discloses an electronics unit of a fluid sensor which is arranged in a housing of the measurement transducer. The electronics unit comprises modular, plastic spacers, each of which holds an electronics component.

To shield the electronics unit from unwanted electrical or electromagnetic effects, the housing of the measurement transducer is usually made of metal. For housings made of electrically non-conductive material, alternative grounding and EMC concepts are necessary. For example, shielding plates can be provided in the housing interior, which are designed to shield the electronics unit. It is obvious that metallic housings of existing products cannot be easily replaced by plastic housings.

The object of the invention is to remedy this problem.

The object is achieved by the measurement transducer according to claim 1 and by the field device according to claim 15.

The measurement transducer according to the invention for a field device for metrology and automation for processing a measurement signal from a sensor and providing measurement values of at least one process variable, comprising:
a housing with a housing body which has in the housing interior thereof at least one housing chamber, which is enclosed by a housing wall,
an electronics unit with at least one electronics module, which has a module holder and an electronics component arranged in the module holder,
   characterized in that the module holder has a module holder body which is, in particular, completely electrically conductive and in that the electronics module, in particular the module holder, is designed to shield the at least one electronics component from undesired electrical or electromagnetic effects.

The advantage of this solution is that the shielding of the electronics unit is not done via the housing, but via the electronics unit itself. For this purpose, the electronics unit has at least one module holder which is designed in such a way that the electronic components arranged in the module holder neither interfere with other devices through unwanted electrical or electromagnetic effects nor are interfered with by other devices. The electronics unit itself is therefore electromagnetically compatible (EMC). It is particularly advantageous if the electronics unit, in particular the at least one module holder, complies with the applicable EMC standards. The European EMC directive defines electromagnetic compatibility as “the ability of an apparatus, installation, or system to operate satisfactorily in its electromagnetic environment without causing electromagnetic interference that would be unacceptable to all the apparatuses, installations, or systems present in that environment.” By providing an electrically conductive module holder, the housing does not need to have a shielding property.

Furthermore, the provision of electrically conductive module holders, which are made of metal, for example, results in improved heat dissipation of the heat generated by the electronics components to the interior of the housing.

Advantageous embodiments of the invention are the subject matter of the dependent claims.

One embodiment provides that the housing body have a first housing opening which can be closed off or is closed off by means of a cover,

wherein the electronics unit is designed such that it can be passed through the first housing opening, in particular in the direction of the housing longitudinal axis.

One embodiment provides that the at least one electronics module have a connector via which the module holder body can be electrically connected to a reference potential or is electrically connected to a reference potential.

The reference potential may, for example, be a ground potential. The connector is preferably located directly on the module holder in order to bring shielded cables for connecting to the connector close to the source of interference. This ensures that the interference generated by the electronics components can, immediately after generation, be diverted through the shield connection.

In electromagnetic compatibility (EMC), two aspects are crucial: interference from the electronics shall not escape and disturb other devices, and interference from outside shall not negatively affect the functioning of the device itself. In particular, the shielded cables help to make communication more robust (i.e., less susceptible to interference).

One embodiment provides that the housing body have a second housing opening through which at least the connector is accessible,

wherein the second housing opening can also be closed off or is closed off by a cover.

The advantage of the design is the easier access to the connector and the resulting possibility of using multiple electronics modules. Furthermore, in addition to the connector for the reference potential, further connectors (power supply/IO/modem) can also be provided, which are preferably also accessible via the second housing opening.

One embodiment provides that the at least one electronics module on which the connector is arranged comprise power supply electronics.

Often, interference in the power supply is intercepted and diverted directly via the power supply unit. It is therefore advantageous if the connector is located directly on the module holder, in which the power supply electronics are also mounted.

Typical elements of power supply electronics are fuses to protect against overcurrent, diodes to protect against overvoltage, various filter elements (e.g., capacitors, chokes, resistors), and/or bridge rectifiers (e.g., AD converters). The safety elements and the filter elements are ideally positioned directly at the connector in the device, so that all other components connected downstream are safe and protected from external interference.

One embodiment provides that the housing have only exactly one housing opening for inserting the electronics unit and connecting reference potentials, in particular to the connector.

For small housing sizes, everything is installed and connected through one housing opening. The advantage of this design is the consistent assembly direction in production. In addition, customer access remains in the usual orientation. For large housing sizes, installation is done through the first housing opening, and connection is done through the second housing opening. A further advantage is the space saving compared to multiple housing openings. Each additional housing opening requires space or expands the dimensions of the housing.

One embodiment provides that a measurement amplifier be arranged in the housing chamber between the at least one electronics module and a housing base of the housing. The housing base separates the housing at least from the sensor mounted in the immediate vicinity. A cable also runs through the housing base, via which the measurement signal from the sensor is transmitted to the measurement amplifier. It is advantageous if the distance between the measurement amplifier and the sensor is as small as possible.

One embodiment provides that there be a partition wall between the module holder and the measurement amplifier, which partition wall is designed to shield the measurement amplifier from electrical or electromagnetic effects generated by the at least one electronics component.

The measurement signal transmitted from the sensor to the measurement amplifier is sensitive to interference and must therefore be shielded. In order to prevent interference generated by the electronics components from distorting the measurement signals, it is advantageous to provide between the electronics component and the measurement amplifier a partition wall that has shielding properties. The partition wall can be perforated and/or ribbed. This serves to improve heat dissipation through convection, and/or allows the passage of cables. Furthermore, the partition wall can be designed as a separate component or as an integral part of the module holder.

One embodiment provides that a fastening device be arranged in the housing chamber, via which the at least one electronics module can be connected to the sensor, wherein the fastening device is designed, in particular completely, to be electrically conductive and is in electrical contact with the electronics unit, in particular with the first electronics module and preferably with the module holder.

This ensures a direct electrical connection and the best possible electrical connection between the sensor and the electronics module.

One embodiment provides that an electrical connection between the sensor, in particular an electrically conductive portion of the sensor, and the connector be made exclusively via the fastening device.

The electrical connection between the sensor and the electronics unit or electronics module is therefore independent of the housing material and the electrical housing properties. The electrical structure of the electronics unit remains identical with or without conductive housing material.

One embodiment provides that the fastening device have an interior in which the measurement amplifier is arranged.

In order to achieve sufficient shielding of the measurement amplifier, it is advantageous if it is surrounded by a metallic body. It is particularly advantageous if the fastening device provided for the mechanical connection of the sensor to the electronics unit is also designed and constructed to shield the measurement amplifier from undesired electrical and electromagnetic effects. This results in a more compact design.

One embodiment provides that the fastening device have a fastening device opening through which the measurement amplifier can be electrically connected to the at least one electronics module.

One embodiment provides that the electronics unit comprise an, in particular electrically conductive, module holder cover, which is designed to shield the at least one electronics component from undesired electrical or electromagnetic effects.

The module holder cover provides shielding from the EMC interference towards the outside, which is generated by the covering electronics component, and shields the covering electronics component from external EMC interference. The module holder cover can be designed as a separate component or as an integral part of the module holder.

One embodiment provides that at least one electronics component be arranged on the module holder cover, which is insensitive to undesirable electrical or electromagnetic effects.

One embodiment provides that the module holder at least partially have a circumferential collar which carries the electronics component in the region delimited by the collar.

The collar encloses the electronics component at least in portions. This serves to shield the electronics component from EMC interference. Furthermore, the collar is designed and configured to absorb the heat of the electronics component and release it to the surroundings of the housing interior. On the one hand, heat dissipation occurs automatically through the surface of the holder, which is per se larger than the surface of the electronics component, and on the other, it can also be forced by large-area, thermally well-conducting connections to other module holders and finally to the housing or preferably the sensor, which is at least partially metallic.

One embodiment provides that the module holder have an, in particular completely, electrically conductive base which fills at least a large part of the region delimited by the collar.

The base can be perforated and/or ribbed. This serves to improve heat dissipation, and/or allows the passage of cables. Furthermore, the base can be designed as a separate component or as an integral part of the module holder. In an advantageous embodiment, the base of the partition wall corresponds to the module holder.

One embodiment provides that the electronics component comprise a circuit board with a measuring and/or operating circuit and/or a circuit board for voltage conversion or conditioning.

One embodiment provides that the module holder have a lateral opening for an electrical plug connector, which is in electrical contact with the electronics component arranged in the corresponding module holder and to which a plug with cable can be plugged.

One embodiment provides that the electronics unit comprise at least two electronics modules,

wherein the at least two electronics modules are stacked on top of one another.

According to the design, the electronics unit is a type of modular system. By using more than one electronics module, customer-specific configurations can be realized with regard to the electronics components and requirements for the measurement transducer. The respective electronics components are usually different, i.e., they assume different functions. For example, one electronics module may comprise an operating, measuring, and/or evaluation circuit, and another electronics module may comprise a voltage converter. The modularity also makes the electronics unit easy to expand. This is particularly advantageous if the customer wishes to provide additional signal outputs (e.g., fieldbuses) in the measurement transducer.

One embodiment provides that the module holders of the at least two electronics modules have substantially the same outline when viewed in the direction of a longitudinal axis of the housing.

One embodiment provides that the at least two electronics modules be connected to one another via a fastening element, which is in particular designed to be electrically conductive.

One embodiment provides that the module holders sit on top of one another, on their axial edges, which are in particular electrically conductive.

A field device according to the invention for metrology and automation for monitoring and/or determining at least one process variable of a medium comprises:
a sensor for detecting at least one measurement signal representing the process variable of the medium,
a measurement transducer according to any of the preceding claims, with measurement transducer electronics which are designed to process the measurement signal from the sensor and to provide measurement values of the at least one process variable,
   wherein the sensor is mechanically and electrically connected to the measurement transducer.

The invention is explained in greater detail with reference to the following figures, in which:

FIG. 1 shows two views of a design of the field device;

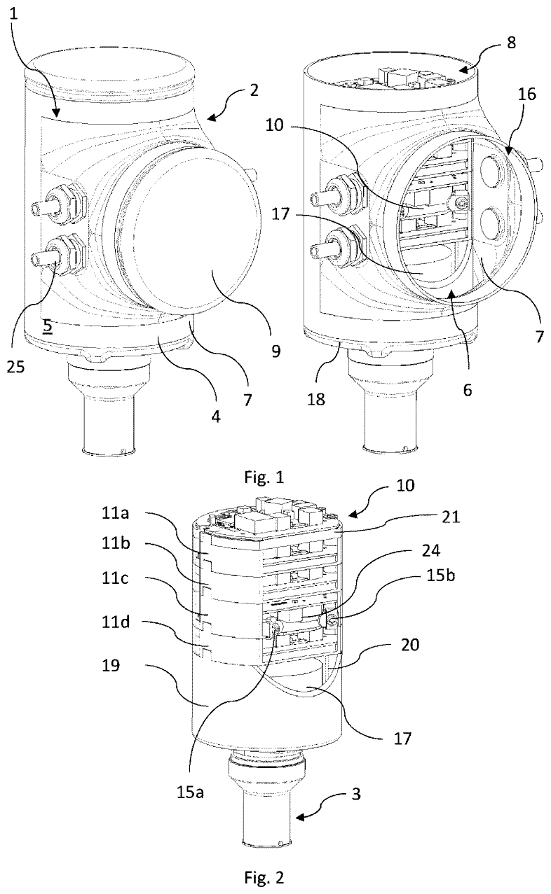

FIG. 2 shows a design of the internal part of the measurement transducer, in particular the electronics unit; and

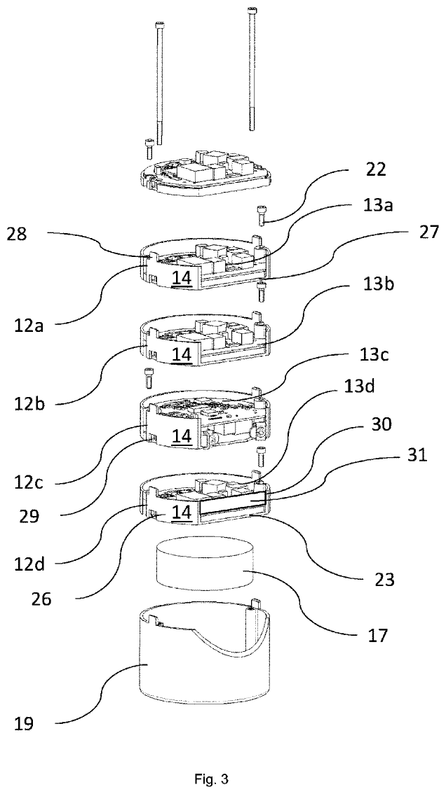

FIG. 3 shows an exploded view of the design of the electronics unit.

FIG. 1 shows a view of an embodiment of the field device according to the invention for metrology and automation 2 for monitoring and/or determining at least one process variable of a medium, with a sensor 3 and a measurement transducer 1, which are both mechanically and electrically connected to each other. Alternatively, the measurement transducer 1 may also be connected only electrically to the sensor 3, and not mechanically. The sensor 3 is designed to detect at least one measurement signal representing the process variable of the medium. The sensor 3 can, for example, be the measuring sensor of a Coriolis flowmeter, of a magnetic-inductive flowmeter, of a magnetic-inductive flowmeter probe, of a thermal flowmeter, of a vortex flowmeter, or of an ultrasonic flowmeter. The measurement transducer 1 has a housing 4 with two housing openings 8, 16 closed by cover 9. The housing 4 has a preferably electrically insulated housing body 5, in the interior of which at least one housing chamber 6 is located. Thus, the housing 4 can be made of an electrically insulating plastic. The housing body 5 can be formed in one piece or in multiple parts. In the illustrated embodiment, the housing interior has exactly one housing chamber 6. The housing chamber 6 is delimited by the housing wall 7. The housing 4 is mechanically connected to the sensor 3. Furthermore, the housing 4 has four feedthroughs 25 for a cable for supplying the electronics unit with a supply voltage, a ground cable, and/or a cable for transmitting the measurement values to a higher-level process monitoring device.

In the second view, a look into the housing chamber 6 is provided through the two housing openings 8, 16. The first housing opening 8 and the second housing opening 16 can each be closed off by a cover 9. The electronics unit 10 is designed such that it can be passed through the first housing opening 8, in particular in the direction of the housing longitudinal axis. This means that the electronics unit 10 can be inserted and removed through the first housing opening 8. Measurement transducer electronics are arranged in the housing chamber, and are designed to process the measurement signal from the sensor 3 and to provide measurement values of the at least one process variable. The measurement transducer electronics are formed at least partially by the electronics components (see FIG. 3), which are part of an electronics unit 10. The electronics unit 10 is accessible via the second housing opening 16. The installer can then pass a cable through one of the feedthroughs via the second housing opening 16 and connect it to the electronics unit 10.

A more detailed view of the electronics unit 10 is shown in FIG. 2. The electronics unit 10 comprises at least one electronics module 11a. In the illustrated embodiment, more electronics modules than just the at least one electronics module 11a are shown. Overall, the illustrated embodiment has four electronics modules 11a, 11b, 11c, 11d, designed as separate components, which are stacked directly on top of one another. However, modular spacers between the individual electronics modules 11i may also be provided, in which no electronics component is arranged. These serve as placeholders. The electronics modules 11i are designed such that they shield the electronics components arranged therein from unwanted electrical or electromagnetic effects and also shield against the unwanted electrical or electromagnetic effects generated by the electronics components. The electronics module 11c has at least one connector 15i via which it can be electrically connected to a reference potential. In the illustrated embodiment, the electronics module 11c has exactly two connectors 15a, 15b. In the illustrated embodiment, the electronics component arranged in the electronics module 11c consists of power supply electronics 24.

A module holder cover 21, which is in particular electrically conductive, is arranged on the electronics module 11a and is designed to shield at least one of the covered electronics components from undesired electrical or electromagnetic effects. In the illustrated embodiment, the module holder cover 21 is a separate component which is placed on the electronics module 11a. On the module holder cover 21, at least one electronics component is arranged, which is insensitive to unwanted electrical or electromagnetic effects. For example, a connector for a display or service port or a plug for overwriting or updating the stored software can be arranged on the module holder cover 21.

The electronics unit 10 is connected to the sensor 3 via a fastening device 19. Below the electronics unit 10, i.e., between the electronics unit 10 and the sensor 3 and/or the housing base 18, a measurement amplifier 17 is arranged, which is designed to receive the measurement signal of the sensor 3, to amplify it, and to forward it to a measuring and/or evaluation circuit. The fastening device 19 is additionally designed to shield the measurement amplifier 17 from unwanted electrical or electromagnetic effects. The electrical connection of the measurement amplifier 17 to the electronics unit 10 is made via a cable, in particular a data cable and/or supply cable, which extends through a fastening device opening 20.

The housing base 18 can be designed as a separate component and, depending upon the connection concept between the sensor and the housing, can be designed as a collar that encompasses a connecting piece to the sensor, or the sensor itself. Alternatively, the housing base 18 can also be predominantly planar, with corresponding openings for connecting cables for electrically connecting the sensor to the measurement amplifier 17 and/or the electronics unit 10.

FIG. 3 shows an exploded view of the design of the internal part of the measurement transducer from FIGS. 1 and 2. The electronics modules each have a one-piece module holder 12i in each of which an electronics component 13i is arranged. The electronics components 13a, 13b, 13c, 13d are circuit boards. The measuring and/or operating circuit and/or the voltage conversion or voltage conditioning device are arranged on the circuit boards. The module holders 12a, 12b, 12c, 12d each have, in particular completely, electrically conductive module holder bodies 14 which are designed to shield the respective electronics components 13i held from undesired electrical or electromagnetic effects. Thus, the module holder bodies 14 can each be at least partially metallic.

In the illustrated embodiment, four module holders 12a, 12b, 12c, 12d and four electronics components 13a, 13b, 13c, 13d are provided. However, the measuring sensor according to the invention is not limited to a specific number of module holders 12i and electronics components 13i. The electronics unit can therefore comprise exactly one electronics module and thus also exactly one module holder with exactly one electronics component. Likewise, the electronics unit may comprise a plurality of electronics modules, but only one of the corresponding module holders may comprise an electronics component, or, alternatively, all but one of the module holders may carry an electronics component. The module holders 12i each have at least partially a circumferential collar 26, and the respective electronics components 13i are arranged in the region delimited by the collar 26. The height of the collar 26 defines the volume for the electronics components.

Furthermore, the module holders 12i each have an, in particular completely, electrically conductive base which fills at least a large part of the region delimited by the collar. An electronics component 13i is always located on the base 27. In addition, the module holders each have a lateral opening 30 in the collar 26 for at least one electrical plug connector 31, which is in electrical contact with the electronics component 13i arranged in the corresponding module holder 12i, and into which a plug with cable can be plugged. In the embodiment shown, at least two electronics modules have substantially the same outline when viewed in the direction of a longitudinal axis of the housing. As a result, the module holders 12i sit on top of one another on their, in particular electrically conductive, axial edges 26.

Between the module holder 12d and the measurement amplifier 17, there is a partition wall 23 which is designed to shield the measurement amplifier 17 from electrical or electromagnetic effects generated by the electronics component 13d and/or the higher-level electronics components 13a, 13b, 13c. The partition wall 23 is designed as an integral part of the module holder 12b. Alternatively, the partition wall 23 can also be designed as a separate component which is positioned between the module holder 12b and the measurement amplifier 17.

The electronics unit, in this case the electronics modules, can be mechanically connected to the sensor via the fastening device 19. The fastening device 19 is, in particular completely, electrically conductive and is in electrical contact with the electronics unit, in particular with the first electronics module and preferably with the module holder 12d or the module holders 12a, 12b, 12c, 12d. Furthermore, the electrical connection between the sensor, in particular an electrically conductive portion of the sensor, and the module holders 12i, in particular the connector arranged on one of the module holders, is made exclusively via the fastening device 19 and not via the housing body. The fastening device 19 has an interior in which the measurement amplifier 17 is arranged.

Fastening means 22, in particular electrically conductive fastening means, represented by screws, which electrically connect the electronics modules to one another, are part of the illustrated embodiment. Instead of screws, pins, cables, etc., can also be used.

One of the electronics modules, in particular the module holders, can have a lateral electrical plug connector 31 to which an electrical plug with cable can be plugged. Via this electrical plug connector 31, the stack, for example, can, via a cable, be electrically connected to the sensor and/or to the display attached to the housing cover.

When multiple electronics modules are used, it is advantageous if the mounting brackets each have a guide profile 28 which is designed to be inserted into a profile receptacle 29 of the adjacent module holder. The guide profile 28 can be designed as a projection on the collar 26, and the profile receptacle 29 as a recess on the collar 26.

### LIST OF REFERENCE SIGNS

Measurement transducer 1
Field device for metrology and automation 2
Sensor 3
Housing 4
Housing body 5
Housing chamber 6
Housing wall 7
First housing opening 8
Cover 9
Electronics unit 10
Electronics module 11i
Module holder 12i
Electronics component 13i
Module holder body 14
Connector 15i
Second housing opening 16
Measurement amplifier 17
Housing base 18
Fastening device 19
Fastening device opening 20
Module holder cover 21
Fastening element 22
Partition wall 23
Power supply electronics 24
Feedthroughs 25
Collar 26
Base 27
Guide profile 28

1-15. (canceled)

16. A measurement transducer for a field device used in metrology and automation for processing a measurement signal from a sensor and for providing measurement values of at least one process variable, the measurement transducer comprising:
a housing having a housing body having in a housing interior a housing chamber that is enclosed by a housing wall; and
an electronics unit having at least one electronics module having a module holder and at least one electronics component arranged in the module holder,
wherein the module holder has a module holder body that is electrically conductive and is designed to shield the at least one electronics component from undesired electrical or electromagnetic effects.

17. The measurement transducer according to claim 16,
wherein the housing body has a first housing opening that can be closed off or is closed off by a cover, and
wherein the electronics unit is designed such that it can be passed through the first housing opening in a direction of a housing longitudinal axis.

18. The measurement transducer according to claim 16,
wherein the at least one electronics module has a connector via which the module holder body can be electrically connected to a reference potential or is electrically connected to a reference potential.

19. The measurement transducer according to claim 17,
wherein the housing body further has a second housing opening via which at least the connector is accessible, and
wherein the second housing opening can be closed off or is closed off by a cover.

20. The measurement transducer according to claim 18,
wherein the at least one electronics module having the connector includes power supply electronics.

21. The measurement transducer according to claim 16,
wherein a measurement amplifier is arranged in the housing chamber between the at least one electronics module and a housing base of the housing.

22. The measurement transducer according to claim 21,
wherein a partition wall is provided between the module holder and the measurement amplifier, and
wherein the partition wall is designed to shield the measurement amplifier from electrical or electromagnetic effects generated by the at least one electronics component.

23. The measurement transducer according to claim 21,
wherein a fastening device is arranged in the housing chamber and via the fastening device the at least one electronics module can be connected to the sensor, and
wherein the fastening device is designed to be electrically conductive and is in electrical contact with the electronics unit.

24. The measurement transducer according to claim 23,
wherein an electrical connection between the sensor and the connector is made exclusively via the fastening device.

25. The measurement transducer according to claim 23,
wherein the fastening device has an interior in which the measurement amplifier is arranged.

26. The measurement transducer according to claim 25,
wherein the fastening device has a fastening device opening through which the measurement amplifier can be electrically connected to the at least one electronics module.

27. The measurement transducer according to claim 16,
wherein the electronics unit includes a module holder cover that is designed to shield the at least one electronics component from undesired electrical or electromagnetic effects.

28. The measurement transducer according to claim 16,
wherein the module holder has a partially circumferential collar that defines a volume for the at least one electronics component.

29. The measurement transducer according to claim 28,
wherein the collar is designed to shield the at least one electronics component from electromagnetic compatibility (EMC) interference, and
wherein the collar is designed to absorb heat of the at least one electronics component and release the heat to the housing interior.

30. The measurement transducer according to claim 28,
wherein the module holder has an electrically conductive base that fills at least a large part of an area delimited by the collar.

31. The measurement transducer according to claim 16,
wherein the at least one electronics component includes a circuit board with a measuring and/or operating circuit and/or a circuit board for voltage conversion or conditioning.

32. A field device for metrology and automation for monitoring and/or determining at least one process variable of a medium, the field device comprising:
a sensor for detecting at least one measurement signal representing the at least one process variable of the medium; and
a measurement transducer, including:
a housing having a housing body having in a housing interior a housing chamber that is enclosed by a housing wall; and
an electronics unit having at least one electronics module having a module holder and at least one electronics component arranged in the module holder,
wherein the module holder has a module holder body that is electrically conductive and is designed to shield the at least one electronics component from undesired electrical or electromagnetic effects,
wherein the electronics unit is configured to process the at least one measurement signal from the sensor and to provide measurement values of the at least one process variable, and
wherein the sensor is electrically and mechanically connected to the measurement transducer.
